(19) United States
(12) Patent Application Publication
(10) Pub. No.: US 2002/0056190 A1
(43) Pub. Date: May 16, 2002

(54) Electronic component transfer system and method of transferring electronic components

(76) Inventors: Osamu Arakawa, Tokyo (JP); Yoshiaki Uchino, Tokyo (JP)

Correspondence Address: FLYNN, THIEL, BOUTELL & TANIS, P.C., 2026 Rambling Road, Kalamazoo, MI, 49008-1699, US

(21) Appl. No.: 09/792,767

(22) Filed: Feb. 23, 2001

(30) Foreign Application Priority Data
Feb. 29, 2000 (JP) 2000-54011

(51) Int. Cl. H01F 21/06

(52) U.S. Cl. 29/825

(57) ABSTRACT

A hand of an auto handler comprises a suction section composed of a suction nozzle and a suction pad, a compulsory separation ring and a coil spring. An electronic component is transferred to a given position by allowing the compulsory separation ring to bring into contact with the electronic component at the periphery thereof in a state where the electronic component is sucked by the suction pad. At the given position, air is discharged through the suction pad, while the compulsory separation ring is lowered at the same time, thereby pushing out the electronic component under the suction pad. With the construction, the electronic component can be transferred with assurance while it is less inclined when it is sucked by the suction section.

### BACKGROUND OF THE INVENTION

1. Field of the Invention

The invention relates to an electronic component transfer system and a method of transferring electronic components.

2. Description of the Related Art

A horizontal transfer type auto handler employs a hand for transferring an integrated circuit (IC) while sucking it.

As shown in FIG. 4, the hand of the auto handler comprises a base 1, a suction nozzle 2, a suction pad 3, a compression coil spring (hereinafter referred to as coil spring) 4, and a vacuum generator, not shown.

The suction nozzle 2 is inserted into the base 1 from the opening defined at the lower end of the base 1 and it has a suction pad 3 which is formed of rubber and mounted on the lower end thereof. Although the base 1 is moved up and down by a driving unit, not shown, to suck an electronic component 5 through the suction pad 3, it has the coil spring 4 for absorbing shock when the suction pad 3 sucks the electronic component 5.

A through hole 2a is defined in the suction nozzle 2 at the center thereof. When the through hole 2a is negatively pressurized by the vacuum generator, not shown, as shown in FIGS. 5 and 6, it sucks the electronic component 5 while when air for releasing the electronic component 5 (hereinafter referred to as releasing air) is supplied to the through hole 2a, the electronic component 5 is released through the through hole 2a. When the hand is moved horizontally while sucking the electronic component 5, the electronic component 5 is placed on a guide block 7 which is located at a given position.

Meanwhile, since a lower end 3a of the suction pad 3 is not always horizontally provided, there is a possibility that the electronic component 5 is sucked by the suction pad 3 while it is inclined. In this state, if the electronic component 5 is released from the suction pad 3 to a recess 7a of the guide block 7, the electronic component 5 is placed on the recess while it is inclined, and hence there occurs erroneous placing or mounting of the electronic component 5 in the succeeding step.

There is a possibility to employ a structure, in order to prevent such an erroneous placing or mounting of the electronic component 5, that a ring 11 is provided around the suction pad 3 to lessen the inclination of the electronic component 5 when it is sucked. However, since the lower end of the suction pad 3 protrudes lower than the lower end of the ring 11, the ring 11 merely functions to prevent the inclination of the electronic component 5 when it is sucked.

Since the electronic component 5 is pushed out from the suction pad 3 by releasing air at one position alone of the center thereof, the physical orientation of the electronic component 5 when it is released or falls amplifies the inclination of the electronic component 5 when it is sucked by the suction pad 3 or the inclination of the electronic component 5 when it falls.

Particularly, since a tendency that the electronic component 5 is lighter in weight and thinner in thickness has increased markedly, the electronic component 5 is susceptible to the foregoing physical orientation thereof, namely, to the inclination thereof.

### SUMMARY OF THE INVENTION

The invention has been developed to solve the foregoing problems and it is an object of the invention to transfer the electronic component 5 with assurance while lessening the inclination thereof.

To achieve the above object, an electronic component transfer system for transferring an electronic component 50 of the first aspect of the invention comprises, as shown in FIGS. 1 and 2, a suction section 32, 36 provided at a lower end of the electronic component transfer system for sucking the electronic component 50, and an electronic component separation section 37 surrounding the suction section 32, 36 and connecting to the suction section 32, 36 while sliding along the suction section 32, 36, wherein a lower end of the electronic component separation section 37 protrudes lower than the lower end of the suction section 32, 36.

According to the first aspect of the invention, the lower end of the electronic component separation section 37 is brought into contact with the electronic component 50 in a state where the electronic component 50 is sucked by the suction section 32, 36 at the lower end thereof. Accordingly, the inclination of the electronic component 50 when it is sucked by the suction section 32, 36 is lessened.

Further, the suction of the electronic component 50 by the suction section 32, 36 is released at the given position and the electronic component separation section 37 is lowered to push out the electronic component 50 thereby. Accordingly, the electronic component 50 can be transferred with assurance while it is pushed out in a horizontal state.

Still further, since the electronic component separation section 37 forcibly pushes out the electronic component 50, the electronic component 50 can be transferred much faster compared with the conventional electronic component transfer system. According to the third aspect of the invention, the electronic component separation section 37 may be, for example, cylindrical.

The electronic component transfer system of the second aspect of the invention is characterized in further comprising urging means 39 for applying an urging force to the suction section 32, 36 so that the lower end of the suction section 32, 36 protrudes lower than the lower end of the electronic component separation section 37.

According to the second aspect of the invention, since the urging means urges the electronic component separation section 37 so that the electronic component separation section 37 is placed under or protrudes lower than the suction section 32, 36, the electronic component separation section 37 is kept in a state where it is brought into contact with the electronic component 50, and the electronic component separation section 37 can push out the electronic component 50 with assurance. The urging means is formed of, for example, elastic member such as a compression coil spring.

The electronic component transfer system of the third aspect of the invention is characterized in that the electronic component separation section 37 in the first and second aspects of the invention, is, for example, cylindrical as shown in FIG. 1.

The electronic component transfer system of the fourth aspect of the invention is characterized in the lower end of the electronic component separation section 37 in the third of the invention, for example, holds the electronic component 50 thereon substantially horizontally as shown in FIG. 1.

The electronic component transfer system of the fifth aspect of the invention is characterized in that the urging force of the urging means 39 in any of the first to fourth aspects of the invention, for example, is weaker than a force to suck the electronic component 50 by the suction section 32, 36 as shown in FIG. 1.

A method of transferring electronic components of a sixth aspect of the invention comprises, for example, as shown in FIGS. 1 to 3, the steps of transferring an electronic component 50 to a given position by allowing an electronic component separation section 37 to bring into contact with the electronic component in a state where the electronic component 50 is sucked by suction section 32, 36, releasing the electronic component 50 from the suction section 32, 36 by discharging air through the suction section 32, 36 at the given position, while the electronic component separation section 37 is moved at the same time, thereby pushing out the electronic component 50 under the suction section 32, 36.

According to the sixth aspect of the invention, since the electronic component separation section 37 is brought into contact with the electronic component 50 while the electronic component 50 is sucked by the suction section 32, 36, the inclination of the electronic component 50 can be lessened when it is sucked. Further, the electronic component 50 is forcibly pushed out downward from the suction section 32, 36 at the electronic component separation section 37, the electronic component 50 can be transferred faster than that in the conventional electronic component transfer system with assurance while the electronic component 50 is pushed out in a horizontal state.

### BRIEF DESCRIPTION OF THE DRAWINGS

FIG. 1 is a longitudinal sectional view showing the construction of an electronic component transfer system according to a preferred embodiment of the invention to which the invention is applied.

FIG. 2 is a longitudinal sectional view showing a state where an electronic component is sucked by the electronic component transfer system in FIG. 1;

FIG. 3 is a longitudinal sectional view showing a state where the electronic component is pushed out by the electronic component transfer system in FIG. 1;

FIG. 4 is a longitudinal sectional view showing the construction of a conventional electronic component transfer system;

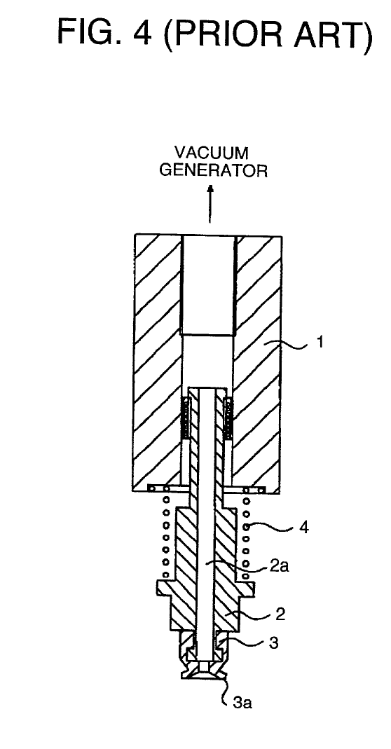

FIG. 5 is a longitudinal sectional view showing a state where an electronic component is sucked by the electronic component transfer system in FIG. 4;

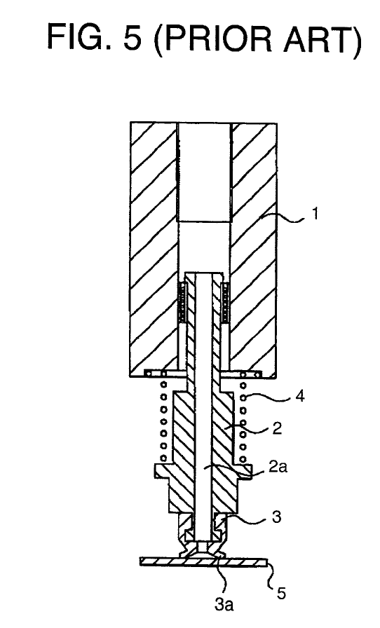

FIG. 6 is a longitudinal sectional view showing a state where the electronic component is pushed out by the electronic component transfer system in FIG. 4; and

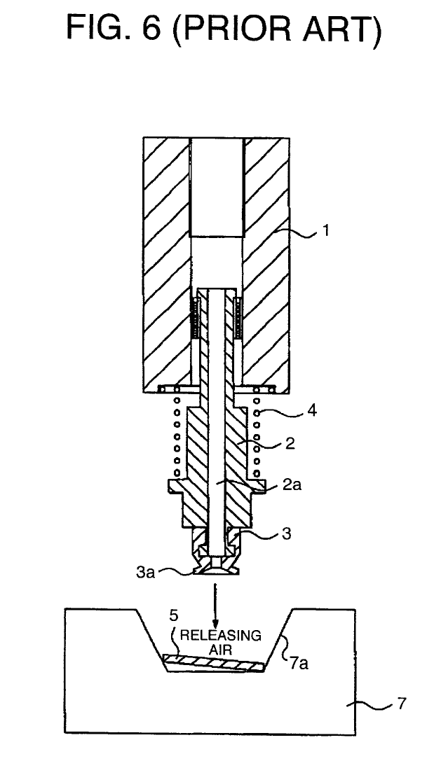

FIG. 7 is a longitudinal sectional view showing the construction of another conventional electronic component transfer system.

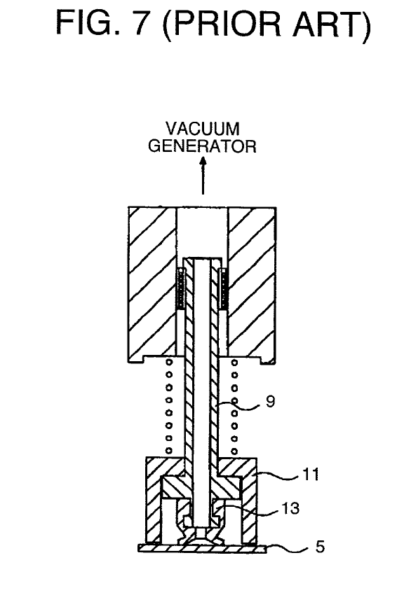

### PREFERRED EMBODIMENT OF THE INVENTION

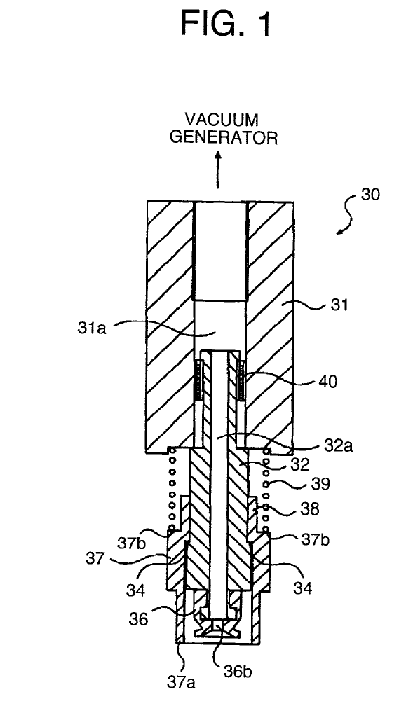

A preferred embodiment of the invention is now described with reference to FIGS. 1 to 3.

The preferred embodiment of the invention is applied to an auto handler. The construction of a hand 30 of the auto handler is first described.

As shown in FIG. 1, the hand 30 comprises a suction section composed of a base 31, a suction nozzle 32 and a suction pad 36, a compulsory separation ring (electronic component separation section) 37, a compression coil spring (urging means) (hereinafter referred to as coil spring) 39, and a vacuum generator, not shown.

The base 31 has a hollow portion 31a, and it is opened at the lower end thereof. The suction nozzle 32 is inserted into the hollow portion 31a of the base 31, and a bearing 40 is interposed between an inner wall of the hollow portion 31a of the base 31 and an outer wall of the suction nozzle 32 at the upper end side. The suction nozzle 32 is connected to the base 31 while the former slides along the latter.

A through hole 32a is defined in the suction nozzle 32 and a come out stopping step 34 is formed on the outer periphery of the suction nozzle 32. The hand 30 is moved up and down by a driving unit, not shown.

The suction pad 36 is mounted on the lower end of the suction nozzle 32. The suction pad 36 has a hollow portion 36b and it is formed of rubber-like member which is opened at the lower end.

The compulsory separation ring 37 is a cylindrical member which surrounds the periphery of the suction nozzle 32, and is movable up and down along the suction nozzle 32.

The compulsory separation ring 37 has a come out stopping step 38 which protrudes inward in the direction of the diameter thereof, and a coil spring attachment section 37b which protrudes outward in the direction of the diameter thereof. A lower end 37a of the compulsory separation ring 37 is flat and is disposed in a horizontal state.

The come out stopping step 38 is disposed over the come out stopping step 34 and the lower end of the compulsory separation ring 37 protrudes under the lower end of the suction pad 36 in a state where the upper come out stopping step 38 is brought into contact with the lower come out stopping step 34.

The coil spring 39 is interposed between the coil spring attachment section 37b of the compulsory separation ring 37 and the lower end of the base 31 and it always urges the compulsory separation ring 37 downward.

The urging force of the coil spring 39 is sufficiently weaker than the suction force of the suction pad 36 for sucking an IC (electronic component) 50. When the electronic component 50 is sucked by the suction pad 36, the compulsory separation ring 37 is pushed upward by the electronic component 50.

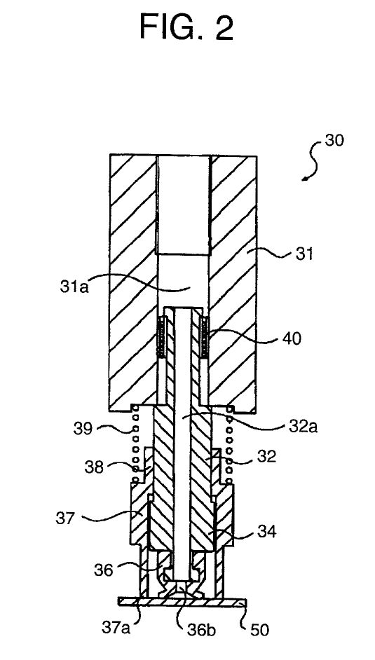

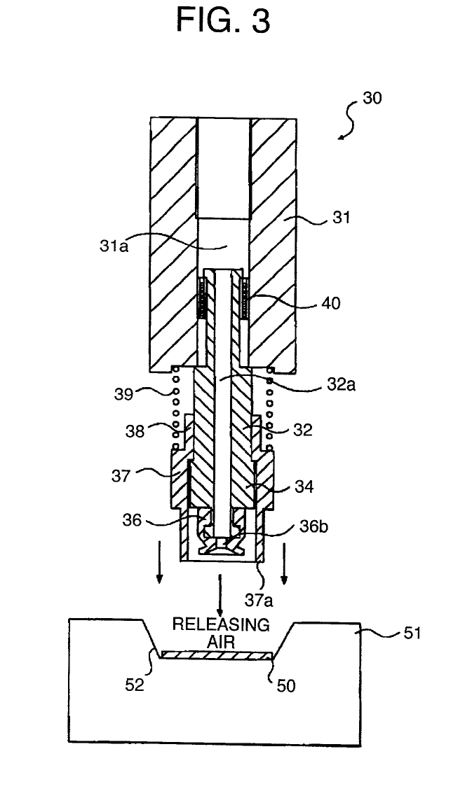

A method of transferring the electronic component 50 is described hereinafter with reference to FIGS. 2 and 3.

The suction pad 36 and compulsory separation ring 37 are pressed against the electronic component 50 which is installed in a given position, then the inside of the through hole 32a is negatively pressurized by the vacuum generator so that the electronic component 50 is sucked by the suction pad 36. Thereafter, the electronic component 50 is moved over a recess 52 of a guide block 51 which is disposed at a given position.

Releasing air is supplied into the through hole 32a so that the electronic component 50 is released from being sucked by the suction pad 36, namely, the suction of the electronic component 50 by the suction pad 36 is released, and the compulsory separation ring 37 is lowered by its own weight and the urging force of the coil spring 39. Then, the electronic component 50 is pushed out downward by the releasing air and the compulsory separation ring 37 so that it is transferred to the recess 52.

According to the preferred embodiment of the invention, the compulsory separation ring 37 is brought into contact with the electronic component 50 at the periphery of the suction pad 36 in a state where the electronic component 50 is sucked by the suction pad 36 so that the inclination of the electronic component 50 can be lessened when it is sucked by the suction pad 36.

Since the compulsory separation ring 37 forcibly pushes out the electronic component 50 from the periphery of the suction pad 36, the electronic component 50 is pushed out in a horizontal state and is much faster transferred to the recess 52 with assurance.

Further, since the compulsory separation ring 37 is urged by the coil spring 39, the compulsory separation ring 37 is kept in a state where it is brought into contact with the electronic component 50. Still further, since the compulsory separation ring 37 is lowered by the urging force of the coil spring 39, the electronic component 50 is pushed out from the suction section with assurance.

According to the foregoing preferred embodiment, although the invention is applied to the auto handler, it is not limited to the auto handler but can be applied to an electronic component packaging or mounting unit.

Still further, although the compulsory separation ring 37 can protrude downward by the urging force of the coil spring 39, it may protrude downward by another elastic member.

More still further, the length of protrusion of the compulsory separation ring 37 is arbitrarily determined, and it is a matter of course that a concrete construction of the compulsory separation ring 37 can be changed appropriately.

According to the first to sixth aspects of the invention, it is possible to lessen the inclination of the electronic component when it is sucked by the suction section because the lower end of the compulsory separation ring is brought into contact with the electronic component at the periphery of the suction section in a state where the electronic component is sucked by the suction section.

Further, since the compulsory separation ring forcibly pushes out the electronic component from the suction section, the electronic component can be pushed out in a horizontal state so that it is much faster transferred with assurance compared with the conventional electronic component transfer system.

According to the second aspect of the invention, the compulsory separation ring can be kept in a state where it is brought into contact with the electronic component, and the compulsory separation ring pushes out the electronic component with assurance.

What is claimed is:

1. An electronic component transfer system for transferring an electronic component comprising:
a suction section provided at a lower end of the electronic component transfer system for sucking the electronic component; and
an electronic component separation section surrounding the suction section and connecting to the suction section while sliding along the suction section;
wherein a lower end of the electronic component separation section protrudes lower than the lower end of the suction section.

2. The electronic component transfer system according to claim 1, further comprising urging means for applying an urging force to the suction section so that the lower end of the suction section protrudes lower than the lower end of the electronic component separation section.

3. The electronic component transfer system according to claim 1, wherein the electronic component separation section is cylindrical.

4. The electronic component transfer system according to claim 3, wherein the lower end of the electronic component separation section holds the electronic component thereon substantially horizontally.

5. The electronic component transfer system according to any of claims 1 to 4, wherein the urging force of the urging means is weaker than a force to suck the electronic component by the suction section.

6. A method of transferring electronic components comprising the steps of:
transferring an electronic component to a given position by allowing an electronic component separation section to bring into contact with the electronic component in a state where the electronic component is sucked by the suction section;
releasing the electronic component from the suction section by discharging air through the suction section at the given position, while the electronic component separation section is moved at the same time, thereby pushing out the electronic component under the suction section.
